(19) United States
(12) Patent Application Publication
(10) Pub. No.: US 2026/0203221 A1
(43) Pub. Date: Jul. 16, 2026

(54) LOCKING DATA BLOCKS IN CACHE

(71) Applicant: Telefonaktiebolaget LM Ericsson (publ), Stockholm (SE)

(72) Inventors: Ganapathy Raman MADANAGOPAL, Bengaluru (IN); Martin JULIEN, Montreal, Québec (CA); Anshuj GARG, Jabalpur (IN)

(73) Assignee: Telefonaktiebolaget LM Ericsson (publ), Stockholm (SE)

(21) Appl. No.: 19/135,758

(22) PCT Filed: Dec. 7, 2022
(86) PCT No.: PCT/EP2022/084686

§ 371 Date: Jun. 4, 2025

(51) Int. Cl. G06F 12/0802

(52) U.S. Cl. CPC G06F 12/0802; G06F 2212/60

(57) ABSTRACT

A method (600) performed by a cache locking module, CLM (330), for locking data in a cache (250) of a processing unit (702). The method includes the CLM configuring (s602) at least a first partition (310) of the cache such that the first partition of the cache is exclusive to the CLM. The method also includes the CLM causing (s604) the processing unit to store in the first partition of the cache a first data block belonging to a first application process.

### TECHNICAL FIELD

Disclosed are embodiments related to systems and method for locking data (e.g. critical application data) in a cache.

### BACKGROUND

There is a growing need for low latency memory access to match the ever-increasing processor speeds found in modern computers. A multitude of memory options varying in storage size and speed of access exist for modern computers. Caches are one of the fastest memory options available, but a cache typically cannot store as much data as compared to other forms of memory such as dynamic random access memory (DRAM) and solid state drives (SSDs).

When a user-space application (or “application” for short) operates on data that is stored in, for example, DRAM, the processing unit on which the application is running will fetch the data from DRAM and may store the data in a cache so that the data can be access more quickly the next time the application needs the data. A cache “miss” occurs when the application requests the data, but the requested data is no longer stored in the cache (e.g., the data was removed (or “evicted”) from the cache). The cache miss causes the processing unit to pull the requested data from another slower memory storage option such as DRAM. The resulting delay increases latency and worsens the overall user experience.

### Cache Replacement

Cache replacement algorithms remove data blocks from the cache with new data blocks that are being used by an application (see, e.g. Wikipedia, “Cache Replacement Policies,” available at en(dot)wikipedia(dot)org/wiki/Cache_replacment_policies). For example, cache replacement algorithms using a least-recently-used (LRU) strategy will remove data blocks whose last access was before any other data blocks in the cache. Another common strategy, least-frequently-used (LFU), entails tracking the number of accesses for data blocks in the cache and removing the data blocks with the least amount of accesses. Other replacement strategies include First-In-First-Out (FIFO), and Random Replacement.

### Cache Partitioning

Cache partitioning is a method that divides a cache into multiple partitions (see, e.g., references [8], [9], and [10]). Each partition can be configured to be exclusive to one or more applications. Thus, if a partition is exclusive to an application, only that application is able to access the cache. Cache partitioning ensures that higher priority applications have greater cache allocation than lower priority applications. Thus, a higher priority application can be protected from having its data blocks stored in cache evicted by a lower priority application's data blocks. Various vendors provide implementations of cache partitioning (see e.g., reference [8] describing an Intel® solution, reference [9] describing an AMD® solution, and reference [10] describing a solution by ARM®).

### Cache Locking

U.S. Patent Publication No. 20060095668 describes a system in which “data is ‘locked’ into [a] cache or other fast memory until it is loaded for use.” Intel's Time Coordinated Computing (TCC) Tools 2021.2 Developer Guide describes cache locking with “Software SRAM.”

### SUMMARY

Certain challenges presently exist. For instance, there is no simple solution presently available to lock an application's data (e.g., critical data) in a cache (e.g., the hardware CPU cache). One potential solution is to modify the cache replacement algorithm from evicting frequently accessed data blocks of the applications. Porting this logic across all cache-eviction algorithms, however, would be challenging and hamper the overall system performance.

A second option is to implement cache-partitioning systems to grant applications exclusive access to certain dedicated partitions. While this option may prevent one application from evicting another application's data from cache, it still faces several setbacks. First, the amount of partitions a cache can be divided into is relatively small. For example, a cache can only be partitioned eight ways in Skylake, and eleven ways in Cascade Lake. Thus, the number of applications seeking to have their critical data locked may outnumber the available partitions. If multiple partitions share blocks, one application's data may cause another's to be evicted from cache. Second, even if one application is able to have an exclusive dedicated cache, the cache clearing function may still clear out the application's critical data blocks with recently accessed blocks of the same application.

A third option is Intel's “Pseudo-Locking” solution, which allows for the pre-allocation of exclusive cache partitions. To implement the technique, an administrator must create a memory region prior to the application instantiation. To use the created memory region for storing data, however, requires applications to be rewritten as existing applications will be unable to use the memory region. Further, the memory region cannot be resized and destroyed at runtime. Accordingly, the lack of flexibility to dynamically create and destroy the special memory can lead to underutilization of the cache.

A fourth option is Intel's DDIO platform technology which enables direct data transfer for I/O data in lieu of the traditional method of transferring data blocks into cache from main memory. While this method helps lower latency, the specialized framework is only applicable for I/O transfers and generic applications cannot take advantage of this framework.

A fifth option is Intel's SRAM, which is a software-based solution for protecting data blocks from being evicted from cache. The size of the locked cache region, however, has to be specified at the boot time. Accordingly, reconfiguring the size of the locked cache region requires rebooting the machines, thereby making it impractical to adjust to new memory locking requirements.

A sixth option is disclosed in US Patent Publication No. 2006/0095668. The solution, however, requires dedicated hardware registers and modification in the cache eviction algorithm to make additional checks using a mapping table. Modifying hardware takes time to implement and fails to incorporate existing systems.

Accordingly, in one aspect there is provided a method a method performed by a cache locking module (CLM) for locking data in a cache of a processing unit. The method includes the CLM configuring at least a first partition of the cache such that the first partition of the cache is exclusive to the CLM. The method also includes the CLM causing the processing unit to store in the first partition of the cache a first data block belonging to a first application process.

In another aspect there is provided a computer program comprising instructions which when executed by processing circuitry of a computing device causes the computing device to perform any of the methods disclosed herein. In one embodiment, there is provided a carrier containing the computer program wherein the carrier is one of an electronic signal, an optical signal, a radio signal, and a computer readable storage medium. In another aspect, there is provided a computing device that is configured to perform the methods disclosed herein. The computing device may include memory and processing circuitry coupled to the memory.

An advantage of the embodiments disclosed herein is that they facilitate the locking of an application's critical data blocks in a cache without being affected by noisy neighbors polluting the cache, or by cache eviction of other data blocks belonging to the same application. Additionally, the embodiments do not require changes to the cache replacement algorithms or system hardware. Further, cache partitions can be dynamically created and destroyed and the number of cache partitions allocated to hold the critical data blocks can be adjusted at run time. Lastly, multiple applications' critical data can be locked in the cache with different partition sizes for different applications.

### BRIEF DESCRIPTION OF THE DRAWINGS

The accompanying drawings, which are incorporated herein and form part of the specification, illustrate various embodiments.

FIG. 1 illustrates a system according to an embodiment for a computing device storing data.

FIG. 2 illustrates a system according to an embodiment for storing data blocks within a partitioned cache.

FIG. 3 illustrates a system according to an embodiment for locking data blocks within a partitioned cache.

FIG. 4 illustrates a system showing different methods for a Cache Locking Module to obtain information indicating that data blocks are critical.

FIG. 5 is a flow chart illustrating a process, according to an embodiment, for locking critical data blocks within cache.

FIG. 6 is a flow chart illustrating a process, according to an embodiment, for locking critical data blocks within cache.

FIG. 7 is a block diagram of a computing device, according to some embodiments.

### DETAILED DESCRIPTION

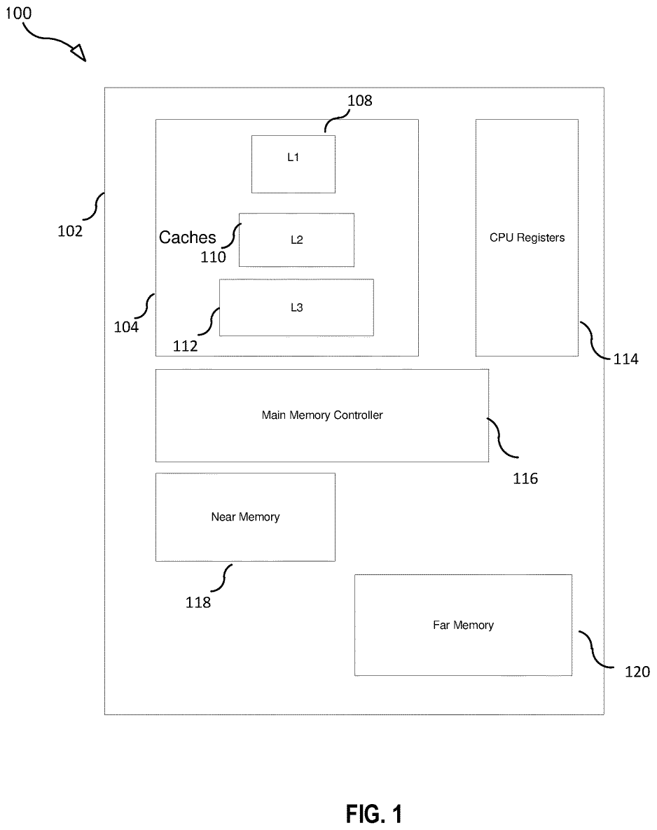

FIG. 1 illustrates a system 100 according to an embodiment for a computing device 102 storing data. The computing device (CD) 102 may include multiple caches 104, CPU registers 114, a main memory controller 116, near memory 118, and far memory 120. The caches 104 may allow for temporary storage of data for quick access. The caches 104 may include an L1 cache 108, an L2 cache 110, and an L3 cache. L1 cache 108 may be the fastest form of cache memory. L2 cache 110 may be slower than the L1 cache 108 but may be able to store larger amounts of data. L3 cache 112 may be able to store the most amount of data of the caches but may be the slowest for accessing memory. Unlike L1 cache 108 and L2 cache 110, L3 cache 112 may be available for memory storage for every core within a CPU chip.

CPU registers 114 may allow for even faster data access than the caches 104. CPU registers 114 may store small amounts of information such as the memory address of frequently accessed data.

The main memory controller 116 may be a digital circuit that manages the flow of data going to and from the computing device's 102 near memory 118. The near memory 118 may contain data currently being used to run an application. The near memory 118 may consist of different forms of random access memory such as DRAM. While the near memory 118 may have greater memory storage capabilities than the caches 104, it may also be far slower for data access. The far memory 120 may comprise various versions of memory storage such as hard disk drive or solid-state drive. The far memory 120 may allow for the greatest memory storage capabilities but the slowest memory access.

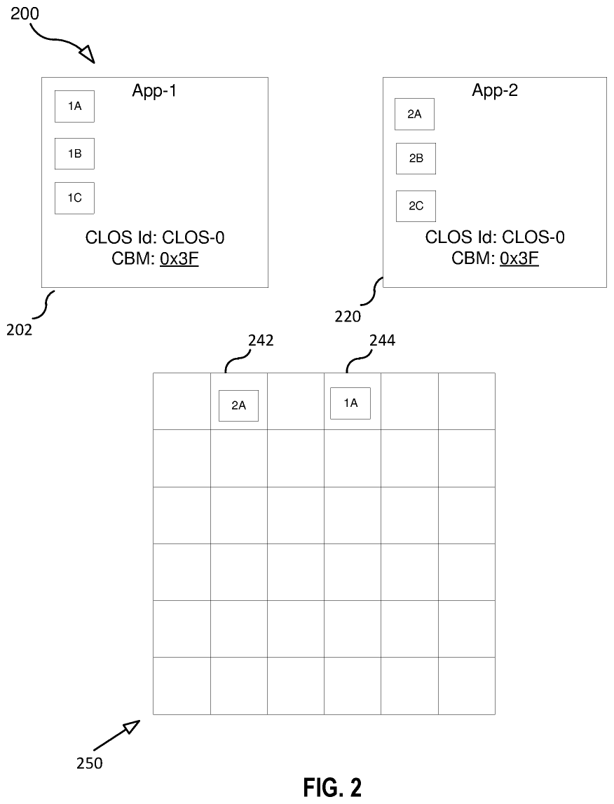

FIG. 2 illustrates a system 200 according to an embodiment for storing data blocks within a partitioned cache. Computing device 102 may be running a first application APP-1 202. The App-1 202 may contain multiple data blocks 1A, 1, and 1C.

The computing device 102 may further have a partitioned cache 250. In some embodiments, the partitioned cache 250 may be within the L3 cache 112. In other embodiments, the partitioned cache may be within the L2 cache 110 or L1 cache 108. The partitioned cache 250 may be divided into six cache partitions.

App-1 may be assigned a group identifier (group ID) (this group ID is referred to herein as a class-of-service ID (CLOS ID)). A CLOS ID assigned to an application may serve as a resource control tag identifying which partitions of the cache can be used by an application. Each CLOS ID is associated with a bitmask, which is a string of bits (e.g., 0101011) that has a corresponding value (hence, each CLOS ID is associated with a value). This bitmask is referred to herein as a capacity bitmask (CBM) and the value corresponding to a CBM is referred to herein as a CBM value. For example, as shown in FIG. 1, App-1 and App-2 are assigned the same CLOS ID (i.e., CLOS-0), and this CLOS ID is associated with a specific CBM value, which in this case is 0x3F in hexadecimal and 111111 in binary.

A CBM value identifies, for the CLOS Id to which the CBM value is assigned, the cache partitions that are available for the applications associated with the CLOS Id. In some embodiments, each bit in the binary representation of the CBM value is associated with a specific cache partition and the value of the bit determines whether or not the specific cache partition is available to an application associated with the CLOS Id to which the CBM value is assigned (e.g., a value of 1 indicates that the cache partition is available for the applications associated with the CLOS id, and a value of 0 indicates that the cache partition is not available for the applications associated with the CLOS id). Accordingly, for a cache having at most six partitions, the maximum CBM hexadecimal value may be 0x3F (in binary 111111). That is, a CBM value of 0x3F assigned to a certain CLOS Id means that all six partitions are available to any application belonging to the certain class identified by that CLOS Id.

Table 1 displays an exemplary assignment of CBMs to CLOS Id.

TABLE 1

| CLOS Id | CBM |
|---|---|
| 0 | 0x3F |
| 1 | 0x3F |
| 2 | 0x3F |

Accordingly, as App-1 is assigned CLOS-0, its CBM value may be 0x3F. Thus, App-1 may be able to access all six partitions within cache 250, and cause the processor of the computing device 102 to store data block 1A within the fourth partition 244 of cache 250.

Further, the computing device 102 may also be running a second application (App-2 220). App-2 220 may have data blocks 2A, 2B, and 2C. App-2 220 may also have CLOS Id CLOS-0 and, hence, a corresponding CBM value of 0x3F. Thus, App-2 may also have access to each partition with cache 250 and cause the processor to store data block 2A into the second partition 242 of cache 250.

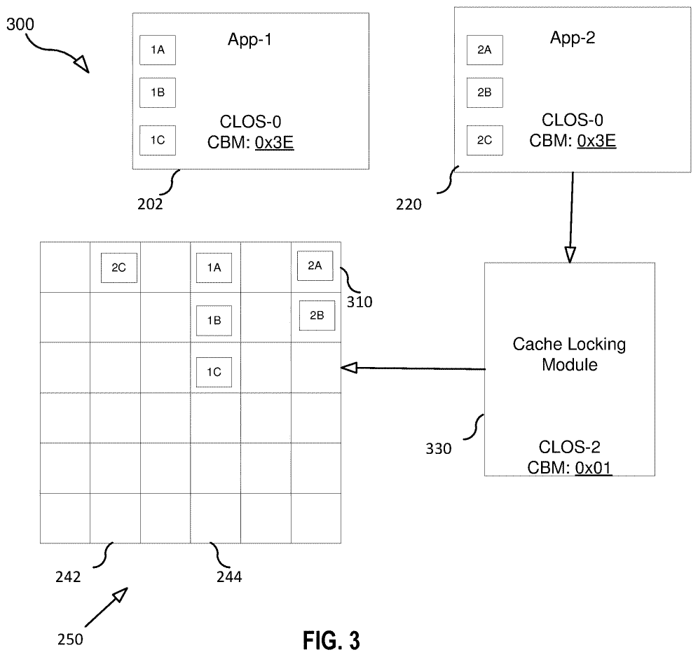

FIG. 3 illustrates a system 300 according to an embodiment for locking data blocks within a partitioned cache.

In some embodiments, a cache locking module (CLM) 330 may be used for locking critical data blocks (e.g., frequently accessed data blocks or requested data blocks) within cache. CLM 330 may be a software module that runs within the kernel space of the computing device 102. CLM 330 may obtain information that data blocks 2A and 2B are critical and need to be locked within the cache. CLM 330 may further obtain the virtual addresses of data blocks 2A and 2B and the process identification (PID) of App-2 220.

Based on the size of data blocks 2A and 2B, CLM 330 may decide the number of dedicated cache partitions to be allocated for locking. In order to lock the data within cache, CLM 330 finds a free CLOS Id (i.e., one that is not assigned to any application) and assigns the free CLOS Id to itself. For example, as shown in FIG. 3, CLM 330 determines that CLOS Id “CLOS-2” is free and self-assigns CLOS-2. CLM 330 may next determine (based on the size of data blocks 2A and 2B) that only single cache partition is needed (e.g., the first cache partition 310) and selects one of the partitions. CLM 330 then sets the corresponding CBM value for CLOS-2 to a value indicating that the selected partition is available (e.g., assuming CLM 330 selected the first partition 310, then CLM sets the CBM value assigned to CLOS-2 to a value of 0x01 (i.e., in binary 000001)).

Accordingly, CLM 330 may be associated with a CBM value of 0x01 because this value is assigned to the CLOS Id to which CLM 330 is assigned. CLM 330 then modifies the corresponding CBM values for the other CLOS Ids (CLOS-0 and CLOS-1) so that the first cache partition 310 is exclusive to the CLM (e.g., CLM changes the CBM for CLOS-0 from 0x3F to 0x3E). Table 2 shows the CLOS Ids and corresponding CBMs after CLM 330 has performed its modification.

TABLE 2

| CLOS Id | CBM in Hex (binary) |
|---|---|
| CLOS-0 | 0x3E (111110) |
| CLOS-1 | 0x3E (111110) |
| CLOS-2 | 0x01 (000001) |

As shown in Table 2, CLOS-0 and CLOS-1 may have their CBM values changed to be 0x3E. CLM 330 may then perform a read function for data blocks 2A and 2B which causes processor to load the data blocks into the dedicated cache partition 310 because that is the only partition available to CLM by virtue of the CBM value assigned to CLOS-2.

In some embodiments, App-2 may cause the processor to store the non-critical data block 2C within the second partition 242. While App-2 may not have access to the exclusive partition, it may still have access to the non-exclusive partitions of cache 250. Further, App-1 may cause the processor to store the non-critical data blocks 1A, 1, and 1C within the fourth partition 244. Similar to App-2, App-1 may have access to the non-exclusive partitions of the cache 250.

In some embodiments, once the critical data blocks have been loaded into the cache 250, CLM 330 may disassociate from CLOS-2. This may prevent CLM 330 from polluting the dedicated cache partition 310.

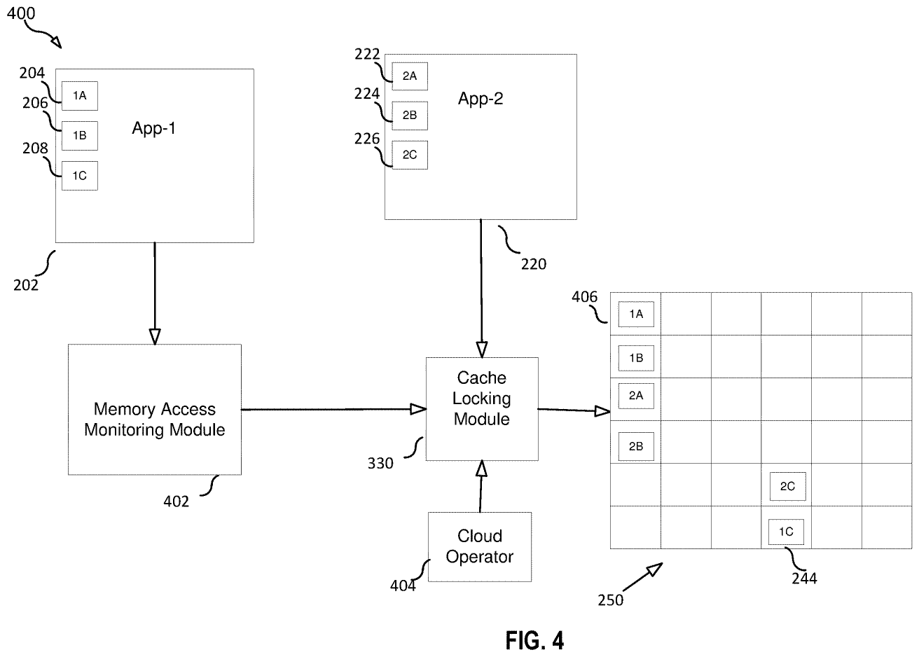

FIG. 4 illustrates a system 400 showing different methods for the CLM 330 to obtain information indicating that data blocks are critical.

In some embodiments, App-2 220 may want to lock its data blocks 2A 222 and 2B 224. In order to designate the data blocks as critical, App-2 220 may transmit the virtual addresses for its data blocks 2A 222 and 2B 224 along with its corresponding PID.

In other embodiments, App-2 may use a system call to instruct the CLM 330 on which data blocks should be locked. For example, CLM 330 may expose system call “cache lock(virtual_address_range_to_be_locked)” to App-2. APP-2 may use the system call “cache lock(virtual_address_range_to_be_locked)” to explicitly specify that the data bocks 2A 222 and 2B 224 are critical.

In other embodiments, App-2 may use the system call mlock( ) as an indicator for locking the data blocks 2A and 2B within cache. Alternatively, App-2 may use the system call “madvise( )” with a new flag MADV_CACHELOCK to instruct the CLM 330 to lock specific pages or through annotations, compilation time flags etc.

CLM 330, upon receiving the information indicating to lock data blocks 2A 222 and 2B 224, may verify whether the App-2 is eligible for locking. In some embodiments, CLM 330 may (at run time) receive a list of applications eligible for locking from the cloud operator 404. For example, the cloud operator may provide the PIDS, the universally unique identifiers (UUID), the name of applications, and the maximum amount of data to be locked in the cache per application. CLM 330 may then verify whether APP-2 is eligible for locking by determining whether the APP-2 is within the list of applications eligible for locking.

In further embodiments, CLM 330 may determine whether the memory requirements of the critical data blocks, 2A and 2B, are within the maximum amount of memory that APP-2 is authorized to lock in cache.

If the APP-2 is eligible for locking then CLM 330 may repeat the process for locking an application as disclosed in FIG. 3 (i.e. assigning a free CLOS-ID to CLM 330, modifying the CBM of the assigned CLOS-Id to map out the partitions of the cache be made exclusive, etc.) and cause the processor to store data blocks 2A 222 and 2B 224 within the first partition 406. In further embodiments, App-2 may cause the processor to store non-critical data block 1C of App-1 in the non-dedicated partition 244.

In other embodiments, a Memory Access Monitoring Module (MAMM) 402 that runs within the kernel space may be configured to track how frequently data blocks are accessed. MAMM 402 may determine the frequently accessed data blocks within App-1 and periodically report the virtual addresses and corresponding PIDS of the frequently accessed data blocks within App-1 determined to be critical to CLM 330.

MAMM 402 may use any number of techniques to track how frequently accessed data blocks are including but not limited to performance monitoring tools like Perf, Intel Hardware based PEBS, Page Table Entry—Dirty Bits and Cache Hits and Misses.

MAMM 402 may determine that data blocks 1A and 1B are accessed frequently enough to be designated critical after monitoring App-1 for a predetermined amount of time. After making the determination, MAMM 402 may send the virtual addresses for the data blocks 1A 204 and 1B 206 along with the PID of App-1 to the CLM 330. The CLM 330 may then use the information provided by the cloud operator to determine whether App-1 is eligible for locking and whether the memory requirements of data blocks 1A and 1B are within the maximum amount of memory authorized for App-1 to lock in cache. If the data blocks are eligible for locking, CLM 330 may undergo the locking process described in FIG. 3 and cause the processor to store the data blocks 1A 204 and 1B 206 into the first partition 406. In further embodiments, App-1 may cause the processor to store the non-critical data block 1C 208 of App-1 in the non-dedicated partition 244.

In some embodiments, the critical data blocks for App-1 (1A and 1B) and the critical data blocks for App-2 (2A and 2B) may be locked within the same partition 406. In other embodiments (after locking the critical data blocks 1A and 1B within first partition 406), CLM 330 may determine that the partition 406 does not have enough memory available to store the critical data blocks 2A and 2B. Accordingly, CLM 330 may use the procedure described in FIG. 3 to create a second dedicated partition in which critical data blocks 2A and 2B may be loaded into.

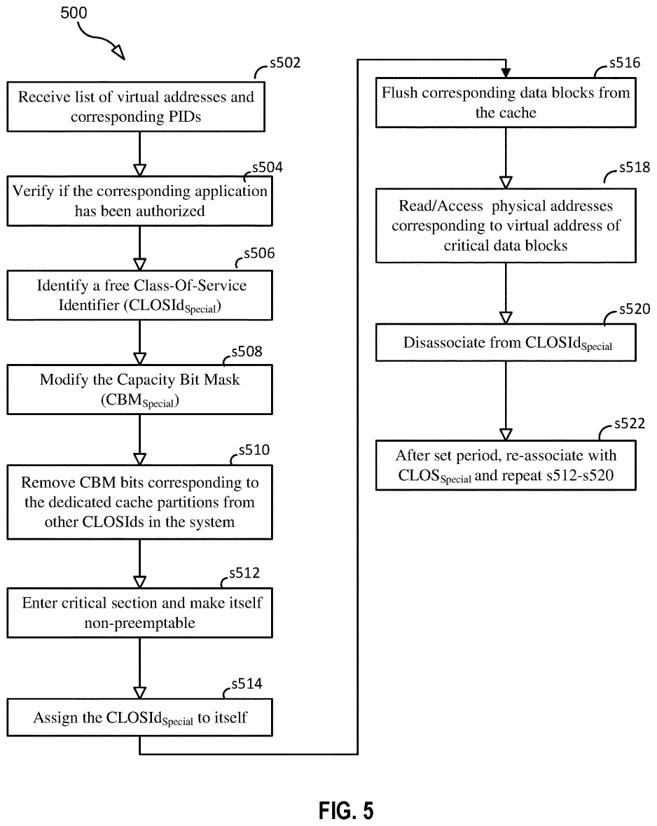

FIG. 5 is a flow chart illustrating a process 500, according to an embodiment, for locking critical data blocks within cache.

Process 500 may begin at step s502. At step s502, the CLM may receive a list of virtual addresses and corresponding PIDs for the data blocks to be locked in the cache (i.e. the blocks are critical).

In some embodiments, the CLM may receive the virtual addresses and corresponding PIDS from applications indicating which data blocks of the applications are critical.

In other embodiments, the frequency at which data blocks are accessed may be monitored in order to determine whether certain data blocks are critical. In further embodiments, a separate software module MAMM may specifically track the frequency at which data blocks are accessed and periodically report the virtual addresses and corresponding PIDs of critical data blocks to the CLM. MAMM may track the frequency of which data blocks are accessed through any number of methods including performance monitoring tools (e.g. Perf, Intel Hardware Based PEBS, etc.), Page Table Entries, and Cache Hits and Misses. Applications that are frequently accessed above some threshold (value) may be deemed critical by MAMM.

At step s504, the CLM may verify if the corresponding application has been authorized. In some embodiments, the CLM may receive (at runtime) information from a cloud operator about which applications are authorized. For example, the cloud operator may provide the PIDs of the applications, the UUIDs, the name of the applications, and the maximum amount of data to be locked in the cache per application.

In further embodiments, the CLM may verify whether total memory required for the critical data blocks are within the maximum amount of data to be locked in the cache per application.

In some embodiments, once the application has been verified, the CLM may identify the type of memory of each critical data blocks. Certain types of memory may be unsuitable for locking such as Memory-Mapped I/O regions. Accordingly, the CLM may use a Page Attribute Table to identify the type of memory of each critical data block and determine whether each data block is of a type of memory eligible for locking.

At step s506, the CLM may identify a free CLOS Id (e.g., CLOSId_{Special}). The CLOS Id may serve as a resource control tag for use in identifying which partitions of the cache can be used by an application. That is, the operating system may be configured to control allocation of the CPU's shared cache based on the CLOS Id assigned to an application. For example, each CLOS id may be configured with a CBM that designates the partitions of the cache that can be accessed by any application to which the CLOS id is assigned. Accordingly, the operating system may allow access to partitions of the cache for applications based on the applications' CLOS Id and its corresponding CBM.

At step s508, the CLM may modify the Capacity Bit Mask (CBM_{Special}) to designate the partitions of the cache to be exclusive. The CLM may determine how much of the cache to make exclusive based on the memory size of the data blocks to be made critical.

At step s510, the CLM may remove the CBM bits corresponding to the dedicated cache partitions from other CLOS Ids in the system. Thus, the dedicated partition may become exclusive to the CLM as other applications CLOS Id will no longer have access to the dedicated partition.

At step s512, the CLM may enter critical section and makes itself non-preemptable.

At step s514, the CLM may assign the CLOSId_{Special} to itself. Thus, when the CLM tries to read/write any data, the corresponding data blocks may be loaded inside the dedicated cache partition.

At step s516, the CLM may flush the corresponding data blocks from the cache. In some embodiments, the CLM may use a page table to identify the physical addresses corresponding to the virtual addresses of critical data blocks. The CLM may flush the blocks using any number of known methods including but not limited to operation codes (opcodes) CLUSH, WBINDV, or CLFUSH. Flushing the existing data blocks out of the cache may ensure that only the dedicated cache partition will serve future cache hits for the critical data blocks.

At step s518, the CLM may read/access the physical addresses corresponding to the virtual addresses of critical data blocks. The CLM reading/accessing the physical addresses may cause the critical data blocks to be loaded in the dedicated cache. In some embodiments, the CLM may flush non-critical data blocks in the dedicated partition before loading the critical data blocks.

At step s520, the CLM may disassociate from CLOSId_{Special}. In some embodiments, the CLM may wait until all the critical data blocks are loaded into the dedicated cache partition before disassociating from CLOSId_{Special}. In further embodiments, the CLM may exit the critical selection and then disassociate from CLOSId_{Special}. The CLM dissociating from the CLOSId_{Special} may prevent the CLM from polluting the dedicated cache partitions. Further, the locked data blocks may continue to serve cache hits.

At step s522, the CLM, after a predetermined amount of time passes, may re-associate with CLOS_{Special} and repeats steps s512-s520. The CLM periodically relocking the critical data blocks in the dedicated partition may prevent corner-cases in which the critical data blocks are flushed outside of the dedicated partition.

In some embodiments in which a second application has critical data blocks that need to be locked, the CLM may re-associate with the CLOSId_{Special} and repeat steps s512-s520 in order to have the second application's data blocks locked in the cache. If the first dedicated partition does not have enough memory available to store the critical data blocks of the second application, the CLM may repeat steps s512-s520 but create a new dedicated partition to store the second application's critical data blocks.

In other embodiments in which an application has frequently accessed data list changes, the CLM may similarly re-associate with the CLOSId_{Special} and repeat steps s512-s520. Similarly as described above, if the first created partition does not have enough memory space to store the new critical data blocks for the application, the CLM may repeat steps s512-s520 but create a new dedicated partition to store the new critical data blocks.

In some embodiments, the CLM may determine whether data blocks locked in cache are no longer required to be locked such as when the data block has been freed by an application or the application is no longer being processed. To make the determinations, the CLM may verify the state of the process and corresponding virtual addresses present in the process virtual memory areas (VMAs) list. If the data block is freed, the CLM may flush the data block out of cache and decrement the count of the active data blocks locked. In some embodiments, an application may us a system call “cache_lock_free( )” to cause the CLM to unlock its critical data blocks from cache.

In further embodiments, in which (after the CLM frees data blocks) there are not enough frequently accessed data blocks to be locked in cache, the CLM may free-up the existing dedicated cache partition by modifying CBM_{Special} and the other CLOSId CBMs so that the dedicated partition is no longer exclusive. Later, if there are enough data blocks to be cached, the CLM may modify CBM_{Special} and other CBMs in order rebuild the dedicated cache partition.

In some embodiments, the partitioned cache maybe within a L3 cache. In other embodiments, the partitioned cache may be within the L2 or L1 cache. In yet other embodiments, the partitioned cache may be extended to lock data-blocks in hierarchical fashion between the L2 and L3 cache based on how frequently accessed/critical a data block is. Data blocks that are highly critical may be locked within the L2 cache while medium critical data blocks can be locked in the L3 cache.

In one example, a computing device may be running an application. When running the application, the computing device may frequently access a data block while running the application. The application may transmit to the CLM the virtual address of the critical data block along with the applications PIDs. The CLM may verify whether the application is authorized for locking. If the application is authorized for locking, the CLM may identify a CLOS Id that is not being used by any other application. The CLM may further modify the CBM associated with the selected CLOS Id to be associated only with the portion of the cache to be locked. The CLM may further modify the CBM of other CLOSId so that no other CBMs allow access to the dedicated cache partition. Next, the CLM may identify the physical addresses of the critical data block using the virtual address and PID. The CLM may next flush the critical data block from cache. After flushing the critical data blocks from cache, the CLM may read the critical data blocks causing them to be stored in the dedicated partition. Once the critical data blocks are stored within the dedicated cache partition, the CLM 330 may disassociate with the selected CLOS Id so that it no longer has access to the dedicated cache partition.

The pseudo code shown in Table 3 below illustrates one possible software implementation of the process 500.

```
TABLE 3
Pseudocode for locking and freeing critical data into cache using an explicit method
(i.e., the user-space application explicitly requests that a certain block of data be
locked in the cache).
1. Steps involved in creating and locking critical data in cache partitions
1.1 Steps performed by the User-space Application
func some_userspace_application_function( )
{
    ...
    ...
    /* Allocate some memory */
    var obj = allocate_memory(2MB)
    // starting location of the pointer
    var start_vaddr = obj
    // size of the data to be locked in the cache starting from the
      start_vaddr
    var size_to_be_locked = 1MB
    var app_pid = getpid( ) // PID of the application
    /* Proposed system call to lock critical data in the cache
      * Args:
      * @start_vaddr: pointer to a virtual memory address
      * @size_to_be_locked: total length of data to be locked in cache
      * @app_pid: PID of the calling process
      */
    var err = cache_lock(start_vaddr, size_to_be_locked, app_pid)
    ...
    ...
}
1.2 Steps performed by the CLM (e.g., Kernel Module)
func cache_lock (start_vaddr, size_to_be_locked, app_pid)
{
    /* Based on the cloud operator's input, verify application has access to lock
      * data
    */
    IF app_pid is NOT in cloud_operator_approved_list
        return error
    /* Check if the size to be locked is within the cloud operator permitted limit
      *(quota)
    */
    IF size_to_be_locked + app_already_locked_size is GREATER THAN
cloud_operator_allowed_quota
        return error
    /* Identify number of dedicated cache partition(s)
      * to be allocated for storing the critical process data
      */
    var size_of_each_cache_partition = total_cache_size /
number_of_cache_partitions
    var required_number_of_cache_partitions = size_to_be_locked /
size_of_each_cache_partition
    /* Check if we can create exculsive partitions from available shared cache
      * partitions
    */
    IF required_number_of_cache_partitions is GREATER THAN
number_of_available_shared_partitions
        return error
    /* get_unallocated_cache_bitmask( ) function will check and return bitmasks
      * of the cache partitions that can be used for applications.
      */
    var special_partition_bitmasks =
get_unallocated_cache_bitmask(required_number_of_cache_partitions)
    /* Remove the special_parition_bitmasks from other CLOSIDs
      * Each CLOSId will hold a file called ‘schemata’ which contains the bitmask of
      * cache partitions allowed to be accesed by tasks associated with the CLOSID
    */
    FOR each CLOSIDs in the system:
        DELETE special_partition_bitmasks from the FILEPATH
/sys/fs/resctrl/CLOS$N/schemata
    /* Identify a free CLOS and associate CLM with the free CLOS
      * This can be done by scanning all the CLOS IDs in the Linux Resctrl interface
      * and check the number of tasks associated with each CLOSId.
      * /sys/fs/resctrl/CLOS$N/tasks
      * CLOSId with no tasks associated becomes the candidate for CLM.
      * By default all the tasks in the system are associated with CLOSID-0
      */
    var closId_special = get_free_clos_id( )
    /* Associate the PID of the CLM with the special CLOSId
      * This can be done by writing the CLM PID into filepath
      * /sys/fs/resctrl/$closId_special/tasks
    */
    WRITE clm_pid into the FILEPATH /sys/fs/resctrl/$closId_special/tasks
    /* Get the Hardware physical address corresponding to the
      * virtual addresses provided by the user application
      * Ref: https://stackoverflow.com/questions/41090469/linux-kernel-how-to-get-
physical-address-memory-management
      */
      var list_of_phy_addrs[ ] = get_virt_to_phys(start_vaddr, size_to_be_locked)
    /* --- Enter the critical section of the code --- */
    SET CLM To Non-PREMPTIBLE and ENTER Critical Section
/* -------------- FLUSH THE DATA FROM THE CACHE -------------- */
    /* METHOD-1: Flush the existing critical data from the cache */
    FOR list_of_phy_addrs:
        CFLUSH (phy_addrs)
    /* METHOD-2: Another optimizated function way Linux provides to acheive same
cache flushing functionality
      * Ref: https://stackoverflow.com/questions/22701352/how-to-flush-the-cpu-
cache-for-a-region-of-address-space-in-linux
      */
      var end_vaddr = start_vaddr + size_to_be_locked
      flush_cache_range(start_vaddr, end_vaddr)
/* --------------------------------------------------------------- */
    /* Associate bitmask of the special cache partitions with special CLOSId
      * by setting the corresponding bitmask
      * in the filename ‘schemata’ -- > which holds the bitmask (CBM)
      */
    WRITE special_partition_bitmasks into the FILEPATH
/sys/fs/resctrl/$closId_special/schemata
/* -------------- READ THE DATA FROM MEMORY TO STORE INTO THE CACHE ----------- */
    /* OPTION-1: Reading the values from the physical address will
      * Load the corresponding data into the special cache parition
      * since we have associated with special CLOS with special bitmask
      * and the only task/pid which is associated with this CLOS is CLM
      */
    FOR each address in list_of_phy_addrs:
        READ value from the physical address
        /* e.g
        * ldr register-1, address--> Load the addr of the memory location
        * into Register-1; or
        * str register-2, [register-1] --> Store the value at memory location into
        * Register-2
        */
    /* OPTION-2: Map the physical address into kernel-space virtual address
      * Access the virtual address to access the user-data in the from memory
      * Developers pefere this method in Linux Kernel.
      * Ref-1: https://stackoverflow.com/questions/10509850/how-to-access-user-
      * space-memory-from-the-linux-kernel
      * Ref-2: https://stackoverflow.com/questions/65924892/access-physical-address-
      * from-kernel-space-in-linux
      */
    FOR each address in list_of_phy_addrs:
        MAP the phy_addr TO kernel_virt_addr
        READ value from the kernel_virt_addr
        /* e.g.
        * void *kern_vadr = phys_to_virt(phys_adr)--> map physical to virtual adr
        * var dummy_var = * kern_vadr --> read and store in dummy variable
        * This will make the data to be loaded into the specical cache partition
        */
/* --------------------------------------------------------------------------- */
    /* Disassociate CLM from the special bitmask
      * Reassign CLM to use shared cache partions
      */
WRITE shared_parition_bitmask into the FILEPATH /sys/fs/resctrl/$closId_special/schemata
    /* --- Exit the critical section of the code --- */
    SET CLM To PREMPTIBLE and EXIT Critical Section
    /* Finally, on success, update the amount of cache locked by the application*/
    app_already_locked_size = app_already_locked_size + new_data_size_locked
    /* Maintain a map/table of PID, virtual address data locked into the
      * corresponding cache paritions
      * Will be useful during deletion/free process
      */
* +----------------------------+-----------+----------------------------------------+
* | Virtual Address Range | PID | Cache Parititions Used for Locking |
* +----------------------------+-----------+----------------------------------------+
* | (start_vaddr1, end_vaddr1) | app_pid_x | special cache paritions bitmasks (CBM) |
* +----------------------------+-----------+----------------------------------------+
* | (start_vaddr2, end_vaddr2) | app_pid_y | special cache paritions bitmasks (CBM) |
* +----------------------------+-----------+----------------------------------------+
* | (start_vaddr3, end_vaddr3) | app_pid_y | special cache paritions bitmasks (CBM) |
* +----------------------------+-----------+----------------------------------------+
* / (start_vaddr4, end_vaddr4) | app_pid_z | special cache paritions bitmasks (CBM) |
* +----------------------------+-----------+----------------------------------------+
*/
    var CLM_TABLE = virtual_address_range(start_vaddr, end_vaddr) MAPS TO app_pid
AND special_partition_bitmasks
    return NO_ERROR
}
//In case of the implicit method, the same function cache_lock ( ) can be called by
the Memory Access Monitoring Module, instead of the user-space application.
2. Steps involved in freeing critical data and deleting cache partitions
2.1 User-space Application
func some_userspace_application_function( )
{
      /* Proposed system call to free critical data from the cache
      * Args:
      * @start_vaddr: pointer to a virtual memory address
      * @size_to_be_locked: total length of data to be locked in cache starting from
start_vaddr
      * @app_pid: PID of the calling process
      */
    var err = cache_free(start_vaddr, size_to_be_locked, app_pid)
}
2.2 CLM Kernel Module which handles cache_free system call
func cache_free (start_vaddr, size_to_be_locked, app_pid)
{
    /* Check if the virtual address and PID is in the CLM_TABLE */
    var end_addr = start_vaddr + size_to_be_locked
    IF app_pid AND vaddr_range(start_addr, end_addr) are NOT PRESENT IN CLM_TABLE
        return error
    /* Get the Hardware physical address corresponding to the
      * virtual addresses provided by the user application
      */
      var list_of_phy_addrs[ ] = get_virt_to_phys(start_vaddr, size_to_be_locked)
    /* Flush corresponding data from cache */*
    flush_cache_range(start_vaddr, end_vaddr)
    /* Update the amount of cache locked by the application */
    app_already_locked_size = app_already_locked_size − size_to_be_locked
    /* Check if there are no other data locked in the corresponding cache
      * partitions
      * Because exclusive cahce partitions can be hold multiple critical data from
      * same process or from another process
      */
    FOR each cache partition from which the data is freed:
      CHECK from CLM_TABLE if cache partition contains no other (locked) critical
        data
        If cache parition has NO other critical data locked:
        // Free the cache parition from exclusive list to the shared list
        // by removing the corresponding bitmask from the special CLOS
        DELETE special_partition_bitmask from FILEPATH
/sys/fs/resctrl/$closId_special/schemata
        //add it all other shared closIds
        ADD special_partition_bitmask to FILEPATH /sys/fs/resctrl/clos$N/schemata
    return NO_ERROR
}
    // In case of implicit method, the same function cache_free ( ) can be called
    by Memory Access Monitoring Module, instead of the user-space application.
    //If the application exits or gets killed, CLM can look into the CLM_TABLE
    (based on the PID) and can flush all the data locked corresponding the
    process.
```

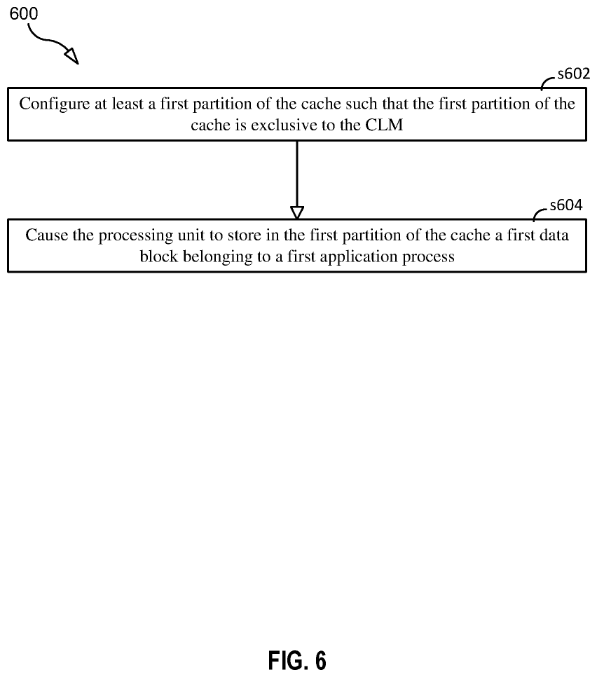

FIG. 6 is a flow chart illustrating a process 600, according to an embodiment, performed by the CLM for locking data in a cache of a processing unit 702 (e.g. the processing unit's L2 cache, L3 cache, etc.).

At step s602, the CLM configures at least a first partition of the cache such that the first partition of the cache is exclusive to the CLM (i.e., no other application process running on the processing unit is able to cause the processing unit to store new data in the first partition of the cache). To configure the first partition as a dedicated cache to be exclusive to the CLM, the CLM may self-assign a free CLOS Id and modify its corresponding CBM to map to the first partition. The CLM may then modify the CBMs of the other CLOS Ids to not include the first partition so that no other application may have access to the first partition.

At step s604, the CLM causes the processing unit to store in the first partition of the cache a first data block belonging to a first application process. In some embodiments, the CLM causes the processing unit to store the first data block in the first partition of the cache by reading the first data block. In some embodiments, prior to the CLM reading the first data block, the CLM obtains a virtual address of the first data block and a process identifier (PID) identifying the first application process. The CLM uses the virtual address and the PID to determine a memory address of a memory location where the first data block is stored. In some embodiments, the CLM reads the first block of data by invoking a read function and passing to the read function the determined memory address.

In some embodiments, the process also includes, after causing the processing unit to store the first data block in the first partition of the cache, the CLM configuring the first partition such that the CLM is not able to cause the processing unit to store new data in the first partition of the cache.

In some embodiments, the process also includes, after the CLM configures the first partition such that the CLM is not able to cause the processing unit to store new data in the first partition of the cache, the CLM i) receiving a request to lock in a cache a second data block or ii) the CLM obtaining information indicating that the second data block is a critical data block; and after receiving the request or obtaining the information indicating that the second data block is critical, the CLM i) again configuring the first partition of the cache such that the first partition of the cache is exclusive to the CLM and ii) causing the processing unit to store the second data block in the first partition.

In some embodiments, the process also includes, after the CLM configures the first partition such that the CLM is not able to cause the processing unit to store new data in the first partition of the cache, the CLM i) receiving a request to lock in a cache at least a second data block or ii) the CLM obtaining the information indicating that the second data block is a critical data block; and after receiving the request or obtaining the information indicating that the second data block is critical, the CLM determining that the first partition of the cache does not have sufficient available memory to store the second data block; after determining that the first partition does not have sufficient available memory, the CLM configuring a second partition of the cache such that the second partition is exclusive to the CLM; and the CLM causing the processing unit to store the second data block in the second cache partition of the cache.

In some embodiments, prior to the CLM configuring the first partition of the cache such that the first partition of the cache is exclusive to the CLM, the CLM obtaining information indicating the first block of data is critical, and the CLM configures the first partition of the cache such that the first partition of the cache is exclusive to the CLM after obtaining the information indicating that the first block of data is critical.

In some embodiments, the process also includes, prior to the CLM configuring the first partition of the cache such that the first partition of the cache is exclusive to the CLM, the CLM receiving from the first application process a cache lock request comprising information indicating a block of data to be locked in the cache, wherein the CLM configures the first partition of the cache such that the first partition of the cache is exclusive to the CLM after receiving the cache lock request, and the block of data comprise the first data block or consists of the first data block.

In some embodiments, causing the processing unit to store the first data block in the first partition of the cache comprises the CLM reading the first data block. In some embodiments, prior to the CLM reading the first data block, the first data block is stored in a second partition of the cache, and causing the processing unit to store the first data block in the first partition of the cache further comprises, prior to reading the first data block, the CLM causing the first data block to be evicted from the second partition of the cache. In some embodiments, the process also includes prior to the CLM reading the first data block, the CLM obtaining a virtual address of the first data block and a process identifier (PID) identifying the first application process, and the CLM using the virtual address and the PID to determine a memory address for a memory location where the first data block is stored, wherein reading the first block of data comprises the CLM using the memory address to read the first block of data.

In some embodiments, using the memory address to read the first block of data comprises: using an assembly instruction to ready directly using the memory address or mapping the memory address to a kernel virtual address and invoking a read operation using the kernel virtual address.

In some embodiments, prior to the CLM configuring the first partition of the cache such that the first partition of the cache is exclusive to the CLM, one or more application processes are associated with a first CLOS, and the first CLOS is associated with a first CBM, the first CBM indicating that the first partition of the cache is available to any application process associated with the first CLOS, an configuring the first partition of the cache such that the first partition of the cache is exclusive to the CLM comprises modifying the first CBM such that the first CBM no longer indicates that first partition of the cache is available to any application processes associated with the first CLOS.

In some embodiments, configuring the first partition of the cache such that the first partition of the cache is exclusive to the CLM further comprises: selecting a CLOS that is not associated with any application process; associating the CLM with the selected CLOS, wherein the selected CLOS is associated with a second CBM; and configuring the second CBM such that the second CBM indicates that the first partition of the cache is available to any process associated with the selected CLOS.

In some embodiments, the process also includes, after the CLM configures the first partition such that the CLM is not able to cause the processing unit to store new data in the first partition of the cache, the CLM obtaining information indicating that a predetermined amount of time has passed; and, based on the obtained information, the CLM i) again configuring the first partition of the cache such that the first partition of the cache is exclusive to the CLM and ii) reading the first data block.

In some embodiments, the process also includes dynamically configuring the amount of the cache that is used to lock data. In some embodiments, dynamically configuring the amount of the cache that is used to lock data comprises: the CLM i) receiving a request to lock in the cache a second data block or ii) the CLM obtaining information indicating that the second data block is a critical data block; the CLM determining that the first partition is not large enough to store both the first data block and the second data block; and as a result of determining that the first partition is not large enough to store both the first data block and the second data block, the CLM i) configuring a second partition of the cache such that second first partition of the cache is exclusive to the CLM and ii) after configuring the second partition of the cache such that second first partition of the cache is exclusive to the CLM, causing the processing unit to store the second data block in the second partition.

In some embodiments, the process also includes the CLM i) receiving a request to lock in the cache a second data block or ii) the CLM obtaining information indicating that the second data block is a critical data block; the CLM determining that the first partition is large enough to store both the first data block and the second data block; and after determining that the first partition is large enough to store both the first data block and the second data block, the CLM causing the processing unit to store the second data block in the first partition.

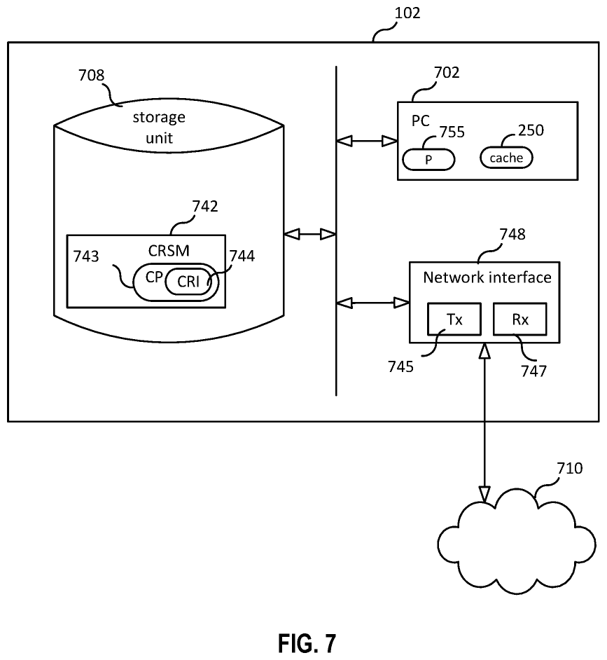

FIG. 7 is a block diagram of computing device (CD) 102, according to some embodiments. As shown in FIG. 7, CD 102 may comprise: processing circuitry (PC) 702 (a.k.a., processing unit 702), which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., CD 102 may be a distributed computing apparatus); at least one network interface 748 (e.g., a physical interface or air interface) comprising a transmitter (Tx) 145 and a receiver (Rx) 747 for enabling CD 102 to transmit data to and receive data from other nodes connected to a network 710 (e.g., an Internet Protocol (IP) network) to which network interface 748 is connected (physically or wirelessly) (e.g., network interface 748 may be coupled to an antenna arrangement comprising one or more antennas for enabling CD 102 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes CD 102 to perform steps described herein (e.g., steps described herein with reference to the flow charts). In other embodiments, CD 102 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] “What is persistent memory?,” available at https://www.netapp.com/data-storage/what-is-persistent-memory/.
[2] “AMD High Bandwidth Memory,” available at https://www.amd.com/en/technologies/hbm.
[3]P. Zheng, A. Narayanan and Z.-L. Zhang, “A Closer Look at NFV Execution Models,” in APNet '19: Proceedings of the 3rd Asia-Pacific Workshop on Networking, 2019.
[4] “Intel Optane PMem module,” available at https://infohub.delltechnologies.com/l/microsoft-sql-2019-on-intel-optane-persistent-memory-pmem-using-dell-poweredge-servers/intel-optane-pmem-module-2.
[5] Pbalcer, “PMem.io,” available at https://pmem.io/blog/2019/12/300-nanoseconds-1-of-2/.
[6] “mlock—Linux manual page,” available at: https://man7.org/linux/man-pages/man2/mlock.2.html.

[7] “Cache Replacement Policies,” available at https://en.wikipedia.org/wiki/Cache_replacement_policies.
[8] “Introduction to Cache Allocation Technology in the Intel® Xeon® Processor E5 v4 Family,” available at https://www.intel.com/content/www/us/en/developer/articles/technical/introduction-to-cache-allocation-technology.htm.
[9] “AMD64 Technology Platform Quality of Service Extensions,” available at https://developer.amd.com/wp-content/resources/56375.pdf.
[10] “Memory System Resource Partitioning and Monitoring (MPAM), for A-profile architecture,” available at https://developer.arm.com/documentation/ddi0598/latest.
[11] “Cache Allocation for Real-Time Systems,” available at https://www.intel.com/content/www/us/en/developer/articles/technical/cache-allocation-for-real-time-systems.html.
[12] Reinette Chatre, “Intel® Resource Director Technology Cache Pseudo-Locking enabling,” available at https://lwn.net/Articles/747214/.
[13] “Intel® Data Direct I/O Technology,” available at https://www.intel.com/content/www/us/en/io/data-direct-i-o-technology.html.
[14] Vikas Shivappa, “Introduction to Cache Quality of service in Linux Kernel,” available at http://events17.linuxfoundation.org/sites/events/files/slides/presentlinuxcon_vikas_0.pdf.
[15] “Intel Cache Allocation Technology and Code and Data Prioritization Features,” available at https://xenbits.xenproject.org/docs/unstable/features/intel_psr_cat_cdp.html.
[16] “CLFLUSH—Flush Cache Line,” available at https://www.felixcloutier.com/x86/clflush.
[17] “WBINVD—Write Back and Invalidate Cache,” available at https://www.felixcloutier.com/x86/wbinvd.
[18] “CLFLUSH,” available at https://c9x.me/x86/html/file_module_x86_id_30.html.
[19] “How to access user space memory from the Linux kernel,” available at https://stackoverflow.com/questions/10509850/how-to-access-user-space-memory-from-the-linux-kernel.
[20] “madvise—Linux manual page,” available at https://man7.org/linux/man-pages/man2/madvise.2.html.
[21] Denis Bakhvalov, “Advanced profiling topics. PEBS and LBR,” available at https://easyperf.net/blog/2018/06/08/Advanced-profiling-topics-PEBS-and-LBR.
[22] “How to access user space memory from the Linux kernel?,” available at https://stackoverflow.com/questions/10509850/how-to-access-user-space-memory-from-the-linux-kernel.
[23] “Page attribute table,” available at https://en.wikipedia.org/wiki/Page attribute_table

1. A method performed by a cache locking module (CLM) for locking data in a cache of a processing unit, the method comprising:
the CLM configuring at least a first partition of the cache such that the first partition of the cache is exclusive to the CLM; and
the CLM causing the processing unit to store in the first partition of the cache a first data block belonging to a first application process.

2. The method of claim 1, wherein the method further comprises, after causing the processing unit to store the first data block in the first partition of the cache, the CLM configuring the first partition such that the CLM is not able to cause the processing unit to store new data in the first partition of the cache.

3. The method of claim 2, wherein the method further comprises:
after the CLM configures the first partition such that the CLM is not able to cause the processing unit to store new data in the first partition of the cache, the CLM i) receiving a request to lock in a cache a second data block or ii) the CLM obtaining information indicating that the second data block is a critical data block; and
after receiving the request or obtaining the information indicating that the second data block is critical, the CLM i) again configuring the first partition of the cache such that the first partition of the cache is exclusive to the CLM and ii) causing the processing unit to store the second data block in the first partition.

3-16. (canceled)

17. A non-transitory computer readable storage medium storing a computer program comprising instructions for implementing a cache locking module; configured to perform the method of claim 1.

18. (canceled)

19. A computing device comprising:
memory; and
a processing unit comprising a cache, wherein
the memory stores a computer program comprising instructions for implementing a cache locking module, (CLM) configured to perform a process comprising:
configuring at least a first partition of the cache such that the first partition of the cache is exclusive to the CLM; and
causing the processing unit to store in the first partition of the cache a first data block belonging to a first application process.

20. The computing device of claim 19, wherein the process further comprises, after causing the processing unit to store the first data block in the first partition of the cache, the CLM configuring the first partition such that the CLM is not able to cause the processing unit to store new data in the first partition of the cache.

21. The computing device of claim 20, wherein the process further comprises:
after the CLM configures the first partition such that the CLM is not able to cause the processing unit to store new data in the first partition of the cache, the CLM i) receiving a request to lock in a cache a second data block or ii) the CLM obtaining information indicating that the second data block is a critical data block; and
after receiving the request or obtaining the information indicating that the second data block is critical, the CLM i) again configuring the first partition of the cache such that the first partition of the cache is exclusive to the CLM and ii) causing the processing unit to store the second data block in the first partition.

22. The computing device of claim 20, wherein the process further comprises:
after the CLM configures the first partition such that the CLM is not able to cause the processing unit to store new data in the first partition of the cache, the CLM i) receiving a request to lock in a cache at least a second data block or ii) the CLM obtaining the information indicating that the second data block is a critical data block; and
after receiving the request or obtaining the information indicating that the second data block is critical, the CLM determining that the first partition of the cache does not have sufficient available memory to store the second data block;
after determining that the first partition does not have sufficient available memory, the CLM configuring a second partition of the cache such that the second partition is exclusive to the CLM; and
the CLM causing the processing unit to store the second data block in the second cache partition of the cache.

23. The computing device of claim 19, wherein
prior to the CLM configuring the first partition of the cache such that the first partition of the cache is exclusive to the CLM, the CLM obtaining information indicating the first block of data is critical, and
the CLM configures the first partition of the cache such that the first partition of the cache is exclusive to the CLM after obtaining the information indicating that the first block of data is critical.

24. The computing device of claim 19, wherein the process further comprises, prior to the CLM configuring the first partition of the cache such that the first partition of the cache is exclusive to the CLM, the CLM receiving from the first application process a cache lock request comprising information indicating a block of data to be locked in the cache, wherein
the CLM configures the first partition of the cache such that the first partition of the cache is exclusive to the CLM after receiving the cache lock request, and
the block of data comprise the first data block or consists of the first data block.

25. The computing device of claim 19, wherein causing the processing unit to store the first data block in the first partition of the cache comprises the CLM reading the first data block.

26. The computing device of claim 25, wherein
prior to the CLM reading the first data block, the first data block is stored in a second partition of the cache, and
causing the processing unit to store the first data block in the first partition of the cache further comprises, prior to reading the first data block, the CLM causing the first data block to be evicted from the second partition of the cache.

27. The computing device of claim 25, wherein the process further comprises:
prior to the CLM reading the first data block, the CLM obtaining a virtual address of the first data block and a process identifier (PID) identifying the first application process, and
the CLM using the virtual address and the PID to determine a memory address for a memory location where the first data block is stored, wherein
reading the first block of data comprises the CLM using the memory address to read the first block of data.

28. The computing device of claim 27, wherein using the memory address to read the first block of data comprises:
using an assembly instruction to ready directly using the memory address, or
mapping the memory address to a kernel virtual address and invoking a read operation using the kernel virtual address.

29. The computing device of claim 19, wherein
prior to the CLM configuring the first partition of the cache such that the first partition of the cache is exclusive to the CLM, one or more application processes are associated with a first class of service, CLOS, and the first CLOS is associated with a first capacity bitmask, CBM, the first CBM indicating that the first partition of the cache is available to any application process associated with the first CLOS, and
configuring the first partition of the cache such that the first partition of the cache is exclusive to the CLM comprises modifying the first CBM such that the first CBM no longer indicates that first partition of the cache is available to any application processes associated with the first CLOS.

30. The method claim 29, wherein
configuring the first partition of the cache such that the first partition of the cache is exclusive to the CLM further comprises:
selecting a CLOS that is not associated with any application process;
associating the CLM with the selected CLOS, wherein the selected CLOS is associated with a second CBM; and
configuring the second CBM such that the second CBM indicates that the first partition of the cache is available to any process associated with the selected CLOS.

31. The computing device of claim 20, wherein the process further comprises:
after the CLM configures the first partition such that the CLM is not able to cause the processing unit to store new data in the first partition of the cache, the CLM obtaining information indicating that a predetermined amount of time has passed; and
based on the obtained information, the CLM i) again configuring the first partition of the cache such that the first partition of the cache is exclusive to the CLM and ii) reading the first data block.

32. The computing device of claim 19, wherein the process further comprises dynamically configuring the amount of the cache that is used to lock data.

33. The computing device of claim 32, wherein dynamically configuring the amount of the cache that is used to lock data comprises:
the CLM i) receiving a request to lock in the cache a second data block or ii) the CLM obtaining information indicating that the second data block is a critical data block;
the CLM determining that the first partition is not large enough to store both the first data block and the second data block; and
as a result of determining that the first partition is not large enough to store both the first data block and the second data block, the CLM i) configuring a second partition of the cache such that second first partition of the cache is exclusive to the CLM and ii) after configuring the second partition of the cache such that second first partition of the cache is exclusive to the CLM, causing the processing unit to store the second data block in the second partition.

34. The computing device of claim 19, wherein the process further comprises:
the CLM i) receiving a request to lock in the cache a second data block or ii) the CLM obtaining information indicating that the second data block is a critical data block;
the CLM determining that the first partition is large enough to store both the first data block and the second data block; and
after determining that the first partition is large enough to store both the first data block and the second data block, the CLM causing the processing unit to store the second data block in the first partition.
